(19) United States
(12) Patent Application Publication
(10) Pub. No.: US 2025/0278074 A1
(43) Pub. Date: Sep. 4, 2025

(54) METHOD AND DEVICE WITH COMPONENT CONFIGURATION CHANGING

(71) Applicant: Samsung Electronics Co., Ltd., Suwon-si (KR)

(72) Inventors: Bo WEI, Suwon-si (KR); Jing LUO, Suwon-si (KR); Xiaoyu HUANG, Suwon-si (KR); Hojae LEE, Suwon-si (KR); Yifei YANG, Suwon-si (KR); Feng ZHU, Suwon-si (KR); Lihao LUO, Suwon-si (KR); Mengfei TONG, Suwon-si (KR); Tao ZHANG, Suwon-si (KR)

(73) Assignee: Samsung Electronics Co., Ltd., Suwon-si (KR)

(21) Appl. No.: 19/067,082

(22) Filed: Feb. 28, 2025

(30) Foreign Application Priority Data
Mar. 1, 2024 (CN) 202410239546.6
Feb. 28, 2025 (KR) 10-2025-0027048

(51) Int. Cl. G05B 19/418

(52) U.S. Cl. CPC G05B 19/41845; G05B 2219/32335

(57) ABSTRACT

A method for changing a component configuration of an apparatus includes: obtaining global change information and state information, the state information corresponding to a current time step, of an environment in which the apparatus is located; obtaining latent features corresponding to candidate actions, based on the state information and based on the global change information; determining candidate action probability values respectively corresponding to the candidate actions, based on the latent features corresponding to the candidate actions; determining a target action based on the candidate action probability values; and changing the component configuration based on the target action.

### CROSS-REFERENCE TO RELATED APPLICATIONS

This application claims the benefit under 35 USC § 119(a) of Chinese Patent Application No. 202410239546.6, filed on Mar. 1, 2024, in the China National Intellectual Property Administration and Korean Patent Application No. 10-2025-0027048 filed in the Korean Intellectual Property Office on Feb. 28, 2025, the entire disclosure of which is incorporated herein by reference for all purposes.

### BACKGROUND

### 1. Field

The present application relates to component reconfiguration, and more specifically, to a method of changing a component configuration and an electronic device.

### 2. Description of Related Art

During a process of producing a product, the configuration of a component of an equipment (e.g., a manufacturing equipment or test equipment) for producing the product may affect capacity for producing the product. A plan for a component configuration may allow adjusting production capacity by changing the component configuration of the equipment to improve production efficiency. The ability to change the component configuration in a timely manner would improve production efficiency.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for changing a component configuration of a component of an apparatus includes: obtaining global change information and state information, the state information corresponding to a current time step, of an environment in which the component configurable apparatus is located; obtaining latent features corresponding to candidate actions, based on the state information and based on the global change information; determining candidate action probability values respectively corresponding to the candidate actions, based on the latent features corresponding to the candidate actions; determining a target action based on the candidate action probability values; and changing the component configuration based on the target action.

The method may further include: changing the state information of the environment based on the changed component configuration, and changing the global change information.

The global change information may include information about the number of times that the component configuration has been changed and information about a time duration from a time at which the current time step is performed to a time when the component configuration was last changed.

The state information of the environment at the current time step may be represented by a state graph or a state matrix.

The state graph may include first type nodes, second type nodes, first type edges connecting the first type nodes and the second type nodes, and second type edges connecting second type nodes to each other; each first type node may represent a kind of product processed by the component configurable apparatus or a kind of processing step by which the component configurable apparatus processes a kind of product, and each second type node represents a kind of component configuration; and a second type edge, pointing from one node of the two second type nodes to the other node, connecting the two second type nodes may represent an action of changing a component configuration represented by the one node to a component configuration represented by another node, a weight of the second type edge may represent a cost of changing from the component configuration represented by the one node to the component configuration represented by another node, and the weight of the second type edge may be predetermined.

The obtaining of the latent features corresponding to the candidate actions may include: obtaining a node feature corresponding to each node of the first type nodes and the second type nodes and a graph feature corresponding to all of the first type nodes and the second type nodes, from the state information by a first neural network; obtaining a candidate action feature corresponding to a candidate action represented by each second type edge, based on two node features corresponding to two nodes connected by each second type edge; obtaining a global change feature from the global change information by a second neural network; and obtaining the latent features corresponding to the candidate actions by merging the candidate action feature corresponding to the candidate action represented by each second type edge, the graph feature, and the global change feature.

The state matrix may include a first matrix and a second matrix, wherein same rows of the matrixes represent a kind of source component configuration, same columns of the matrixes represent a kind of target component configuration, and an element of an i-th row and a j-th column of each matrix represents an attribute corresponding to an action of changing a source component configuration represented by the i-th row to a target component configuration represented by the j-th column; the element of the i-th row and the j-th column of the first matrix may represent: a change in the number of kinds of products that the component configurable apparatus is capable of processing or a change in the number of kinds of processing steps that the component configurable apparatus is capable of performing on products, before and after changing the source component configuration represented by the i-th row to the target component configuration represented by the j-th column; and the element of the i-th row and the j-th column of the second matrix may represent: a cost of changing the source component configuration represented by the i-th row to the target component configuration represented by the j-th column.

The obtaining of the latent features corresponding to the candidate actions may include: obtaining a candidate action features corresponding to the candidate actions from the state matrix by a first neural network; obtaining a global change feature from the global change information by a second neural network; and obtaining the latent features corresponding to the candidate actions by merging each of the candidate action features with the global change feature.

The determining of the candidate action probability values respectively corresponding to the candidate actions may include: obtaining the candidate action probability values from the latent features by a third neural network.

The determining of the target action based on the candidate action probability values may include: determining a candidate action corresponding to a largest candidate action probability value among the candidate action probability values as a target action.

According to some example embodiments, an electronic device includes: an information obtaining module configured to obtain state information, corresponding to a current time step, of an environment in which a component configurable apparatus is located and global change information; a feature obtaining module configured to obtain a latent features corresponding to a candidate actions, based on the state information and the global change information; a probability value determination module configured to determine a candidate action probability values corresponding to the candidate actions, based on the latent features corresponding to the candidate actions; and an action determination module configured to determine a target action based on the candidate action probability values; and a change module configured to change the component configuration based on the target action.

The electronic device may further include an information change module configured to change the state information of the environment based on the changed component configuration, and changing the global change information.

The global change information may include information about the number of times that the component configuration has been changed and information about a time from a time at which the current time step is performed to a time when the component configuration was changed last time.

In the present application, a cost or an impact caused by the global change information is taken into account when changing the component configuration, which may better change the component configuration timely according to the environment to improve the production efficiency.

The state information of the environment at the current time step may be represented by a state graph or a state matrix.

The state graph may include first type nodes, second type nodes, first type edges connecting the first type nodes and the second type nodes, and second type edges connecting two second type nodes; each first type node may represent a kind of product processed by the component configurable apparatus or a kind of processing step by which the component configurable apparatus processes a kind of product, and each second type node represents a kind of component configuration; and a second type edge, pointing from one node of the two second type nodes to the other node, connecting the two second type nodes may represent an action of changing a component configuration represented by the one node to a component configuration represented by another node, a weight of the second type edge may represent a cost of changing from the component configuration represented by the one node to the component configuration represented by another node, and the weight of the second type edge may be predetermined.

In the present application, the action of changing the component configuration is represented by one side in the state graph, which may determine a specific configuration change precisely. In the present application, a weight related to a cost of changing are introduced in the state graph, which may improve the production efficiency more effectively.

The feature obtaining module may be configured to: obtain a node feature corresponding to each node of the first type nodes and the second type nodes and a graph feature corresponding to all of the first type nodes and the second type nodes, from the state information by a first neural network; obtain a candidate action feature corresponding to a candidate action represented by each second type edge, based on two node features corresponding to two nodes at two ends of each second type edge; obtain a global change feature from the global change information by a second neural network; and obtain the latent features corresponding to the candidate actions by merging the candidate action feature corresponding to the candidate action represented by each second type edge, the graph feature, and the global change feature.

The state matrix may include a first matrix and a second matrix, wherein same rows of the matrixes represent a kind of source component configuration, same columns of the matrixes represent a kind of target component configuration, and an element of an i-th row and a j-th column of each matrix represents an attribute corresponding to an action of changing a source component configuration represented by the i-th row to a target component configuration represented by the j-th column; the element of the i-th row and the j-th column of the first matrix may represent: a change in the number of kinds of products that the component configurable apparatus is capable of processing or a change in the number of kinds of processing steps that the component configurable apparatus is capable of performing on products, before and after changing the source component configuration represented by the i-th row to the target component configuration represented by the j-th column; and the element of the i-th row and the j-th column of the second matrix may represent: a cost of changing the source component configuration represented by the i-th row to the target component configuration represented by the j-th column.

The feature obtaining module may be configured to: obtain a candidate action features corresponding to the candidate actions from the state matrix by a first neural network; obtain a global change feature from the global change information by a second neural network; and obtain the latent features corresponding to the candidate actions by merging each of the candidate action features with the global change feature.

The probability value determination module may be configured to obtain the candidate action probability values from the latent features by a third neural network.

The action determination module may be configured to determine a candidate action corresponding to the largest candidate action probability value among the candidate action probability values as a target action.

A computer-readable storage medium stores a computer program that, when executed by a processor, causes the processor to implement any of the methods.

Other features and aspects will be apparent from the following detailed description, the drawings, and the claims

### BRIEF DESCRIPTION OF THE DRAWINGS

The above and other objects, features and advantages of the present disclosure will become clearer through the following detailed description together with the accompanying drawings in which:

FIG. 1 illustrates a system for changing a component configuration according to some example embodiments.

FIG. 2 illustrates a reinforcement learning model according to some example embodiments.

FIG. 3 illustrates a method for changing a component configuration according to some example embodiments.

FIG. 4 shows an example for obtaining state information according to some example embodiments.

FIG. 5 shows another example for obtaining state information according to some example embodiments.

FIG. 6 shows an example for obtaining latent features according to some example embodiments.

FIG. 7 shows another example for obtaining latent features according to some example embodiments.

FIG. 8 shows a method for training an agent according to some example embodiments.

FIG. 9 shows an example for obtaining training data according to some example embodiments.

FIG. 10 shows an example of training a model of a first agent using a proximal policy optimization (PPO) algorithm according to some example embodiments.

FIG. 11 shows another example for obtaining training data according to some example embodiments.

FIG. 12 shows an example of training a model of changing a component configuration using a PPO algorithm according to some example embodiments.

FIG. 13 shows an electronic device according to some example embodiments.

FIG. 14 shows an electronic device according to some example embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

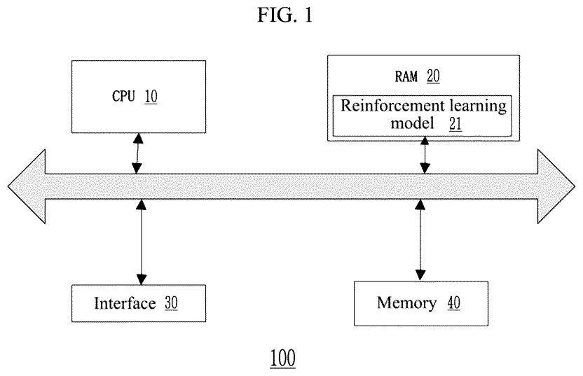

FIG. 1 illustrates a system for changing a component configuration according to some example embodiments.

Referring to FIG. 1, a system 100 may include a central processing unit (CPU) 10, a random access memory (RAM) 20, an interface 30, a memory 40, and a bus. Any form of storage may be used instead of, or in combination with the RAM 20. The system 100 may also include an input/output module, a safety module, a power control device, and the like, and may also include various types of processors. The system 100 may be a data processing system that includes a reinforcement learning model 21.

According to some embodiments, components (e.g., the CPU 10, the memory 40, the interface 30, and/or the RAM 20) of the system 100 may be formed on a single semiconductor chip. For example, the system 100 may be implemented as a system-on-chip (SoC). The components of the system 100 may communicate with each other via the bus.

The CPU 10 controls overall operations of the system 100, for example, by executing an operating system. The CPU 10 may include one or more processing cores. The CPU 10 may process or execute programs and/or data stored in a storage area (e.g., the memory 40). For example, the CPU 10 may control the system 100 as required for the execution of an application program.

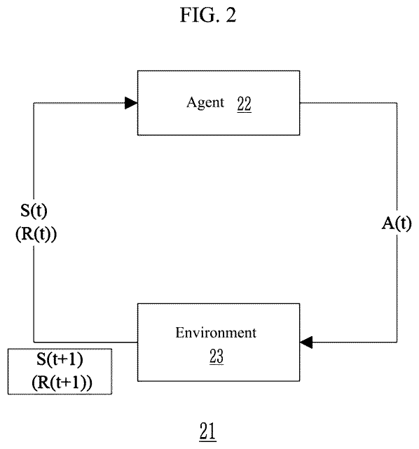

The RAM 20 may store a reinforcement learning model 21. In an example, the reinforcement learning model 21 may be loaded into the RAM 20 from the memory 40. The reinforcement learning model may be of the model-free machine learning type and may include an environment and an agent. The environment (simulated/non-real) may generate state information according to data related to a physical environment in which a component-configurable apparatus (an apparatus with a configurable component) is located. The component-configurable apparatus may be an equipment for producing a product (referred to herein as production equipment) and may be a manufacturing equipment or a test equipment associated with the product. The agent may perform, according to the state information, an action for changing the component configuration. The action may simulate processing of changing one component configuration to another component configuration (of a same component). The environment may change the state information according to the action performed by the agent. The reinforcement learning model 21 is described with reference to FIG. 2.

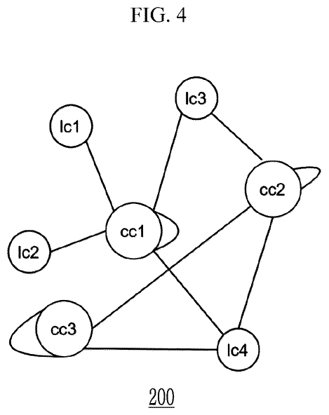

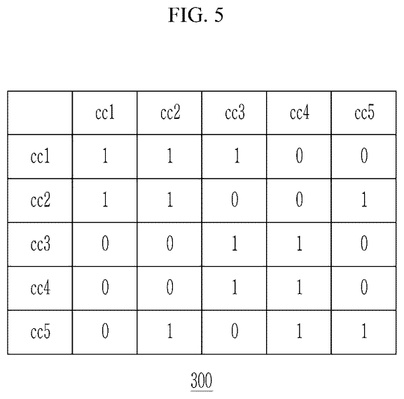

In an example, the state information may include the number (quantity) of the products, types of the products, a time at which the products will be processed, a processing status with a current component configuration of the production equipment, an inventory of the component, etc., however, examples are not limited thereto. An example of obtaining status information is described with reference to FIGS. 4 and 5.

In an example, a component configuration cc of the production equipment may include a model number of the production equipment, a component included in the production equipment, a temperature of an environment in which the production equipment is located, or the like. For example, a kind of component configuration cc of the production equipment may be represented as: cc={tester-handler, board, kit, match plate, T}; tester-handler denotes the model number of the production equipment, board, kit, and match plate denote components that may be included in the production equipment, and T denotes the temperature of the environment in which the production equipment is located. Here, the components board, kit, and match plate may correspond to the model number “tester-handler”, and the components board, kit, and match plate corresponding to the model number “tester-handler” may be assembled together. However, examples are not limited thereto, and the component configuration may also include other information related to the production equipment.

The memory 40 may store programs and/or data used in the system 100. In an example, the memory 40 may store data used to execute the reinforcement learning model 21 and/or train the reinforcement learning model 21. The memory 40 may be a dynamic random access memory (DRAM), but is not limited thereto. The memory 40 may include a volatile memory and/or a non-volatile memory.

The interface 30 may be used to control interconnections and operations of one or more user input and/or output devices. For example, the interface 30 may facilitate connections and use of a keyboard, a mouse, a monitor, a display, etc., thereby allowing for the receipt of commands, instructions, and/or data from a user and also providing audio and/or visual information about progress in changing the component configuration to the user.

FIG. 2 illustrates a reinforcement learning model according to some example embodiments.

Referring to FIG. 2, a reinforcement learning model 21 may include an agent 22 and an environment 23. The agent 22 and the environment 23 may be implemented as hardware within a processor or software running on the processor, or a combination thereof.

In an inference processing, the environment 23 may generate state information (e.g., S(t), S(t+1), . . . ) according to real data associated with an actual environment in which the production equipment is located. In a training processing, the environment 23 may simulate the actual environment in which the production equipment is located by discrete event simulation (DES).

In an example, the agent 22 may include a first neural network for extracting a feature from the state information provided from the environment 23, a second neural network for extracting a feature from global change information, and a third neural network for generating an action according to the extracted feature (e.g., action A(t)). Here, an output end of the first neural network and an output end of the second neural network may be connected to an input end of the third neural network. The above-described agent 22 may be referred to as a first agent. In an example, the global change information may include information about the number of times that the component configuration has been changed and information about a time duration from a time when the current time step is performed to a time when the component configuration was last changed. The first neural network, the second neural network, and the third neural network are described with reference to FIGS. 4 and 5. A cost or an impact caused by the global change information is taken into account when changing the component configuration, which may change the component configuration according to the environment to improve production efficiency.

In another example, the agent 22 may also include a fourth neural network for evaluating the first neural network, the second neural network, and the third neural network. The fourth neural network may be implemented with a multilayer perceptron (MLP), a convolutional neural network (CNN), or the like. For example, a state value output by the fourth neural network may represent a future discounted total return starting from a current time step. Here, in addition to be connected to an input end of the third neural network, and the output end of the first neural network and the output end of the second neural network may be connected to an input end of the fourth neural network. The above-described agent 22 may be referred to as a second agent. In an example, the fourth neural network may be executed in the training processing rather than inference processing.

Processing of generating training data, and processing of inferring, are briefly described next.

In a processing of generating training data for training the models of the agent 22, given current training state information S(t) from the environment 23 and a training reward value R(t) for a previous training action A(t−1), the agent 22 may determine a training action A(t). The environment 23 may then update the training state information S(t) to next training state information S(t+1) according to the training action A(t) determined by the agent 22, and may determine a training reward value R(t+1) based on the updated training state information S(t+1).

In a processing of inferring using the models of the agent 22, given current state information S(t) from the environment 23, the agent 22 may determine an action A(t). The environment 23 may then update state information S(t) to next state information S(t+1) according to the action A(t) determined by the agent 22.

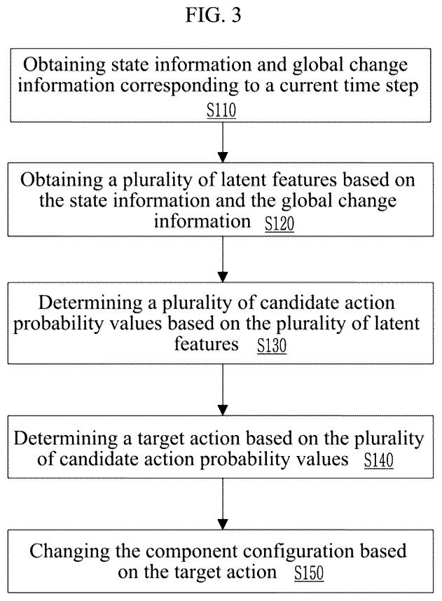

FIG. 3 illustrates a method for changing a component configuration according to some example embodiments.

As shown in FIG. 3, in step S110, state information and global change information may be obtained, the state information corresponding to a current time step (a current iteration) of an environment in which production equipment is located.

The time step is one process step or iteration, i.e., one iteration of changing the component configuration (steps S110 to S150) according to the state information as well as changing the global change information and changing the state information based on the changed component configuration.

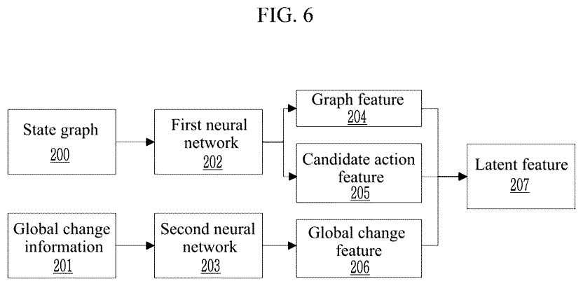

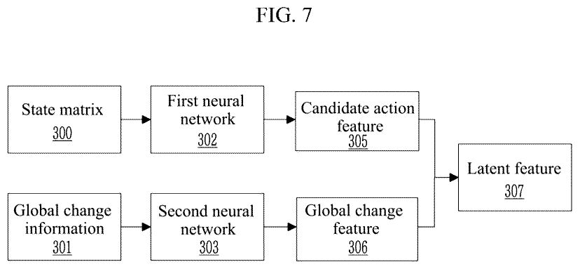

In step S120, latent features corresponding to candidate actions may be obtained (e.g., inferred by the agent) based on the state information and the global change information. Here, the candidate actions may represent a processing of changing a current component configuration to a candidate component configuration. An example of obtaining latent features is described with reference to FIGS. 6 and 7.

In step S130, candidate action probability values respectively corresponding to the candidate actions may be determined based on the latent features corresponding to the candidate actions.

The candidate action probability values may be obtained from the latent features by a third neural network of the agent (e.g., a multilayer perceptron (MLP), a convolutional neural network (CNN), etc.).

In step S140, a target action may be determined based on the candidate action probability values. For example, whichever candidate action corresponds to the maximum candidate action probability value may be determined as the target action.

In step S150, the component configuration may be changed based on the target action. Specifically, after the target action is determined, a component configuration of one of multiple modeled/simulated production equipments that can be configured with the current component configuration (e.g., equipments with a same component) may be changed to a target component configuration corresponding to the target action. The one production equipment may be randomly selected or a production equipment that enters an idle state earliest/next may be selected.

After changing the component configuration, the environment containing the reconfigured production equipment may be changed based on the reconfigured production equipment (changed component configuration), and new state information may be generated by the environment 23 accordingly. In addition, the global change information may be changed.

The above-described processing of changing the component configuration, changing the status information, and the global change information may be performed at a predetermined time interval, for example 1 hour.

With the embodiments and examples described herein, problems related to an optimization and a plan of the component configuration of the component-configurable apparatus is modeled using reinforcement learning, which may efficiently change the component configuration according to the environment to improve the production efficiency.

FIG. 4 shows an example for obtaining state information according to some example embodiments.

State information of an environment in which production equipment is located is shown using a state graph 200.

In an example, the state graph 200 may include first type nodes (e.g., lc nodes), second type nodes (e.g., cc nodes), first type edges connecting the first type nodes and the second type nodes, and second type edges connecting between two second type nodes. In addition, the state graph 200 may also include a third type edge whose two ends are connected to one second type node.

Each lc node of the state graph 200 represents either (i) a kind of product processed by the production equipment or (ii) a kind of processing step by which the production equipment processes a kind of product. In an example, attribute values of each lc node may include, but are not limited to: the number of production equipment that may be used to process a product or a processing step represented by the corresponding lc node; the number of products of a type represented by each lc node that have arrived or the number of products on which a processing step represented by each lc node needs to be performed at a current time, the number of products of a type represented by each lc node that will arrive at the production equipment or the number of products on which a processing step represented by each lc node needs to be performed per hour in the future; and the number of products of a type represented by each lc node will arrive at the production equipment or the number of products on which a processing step represented by each lc node needs to be performed in a predetermined time period (e.g., in next 10 hours) in the future.

Each cc node of state diagram 200 represents a kind of component configuration. In an example, attribute values of each cc node may include, but not limited to: the number of production equipment installed with the component configuration represented by the cc node; the number of products that the production equipment installed with the component configuration represented by the cc node may process in the future; a time required for the production equipment installed with the component configuration represented by the cc node to process products that have currently reached at the production equipment; a time required for the production equipment installed with the component configuration represented by the cc node to process products that will arrive at the production equipment per hour in the future; and a time required for the production equipment installed with the component configuration represented by the cc node to process products that will arrive at the production equipment in a predetermined time period (e.g., in next 10 hours) in the future.

The first type edge connecting the first type node and the second type node may represent that a component configuration represented by the second type node is capable of processing a product or a processing step represented by the first type node. For example, an edge connecting an lc1 node and a cc1 node represents that a component configuration represented by the cc1 node is capable of processing a product or a processing step represented by the lc1 node. For example, the absence of an edge between the lc1 node and a cc3 node represents that a component configuration represented by the cc3 node is not capable of processing the product or processing step represented by the lc1 node.

A second type edges connecting two second type nodes may include two directed second type edges. A second type edge pointing from one of the two second type nodes to the other may represent an action of changing a source component configuration represented by the one to a target component configuration represented by the other. For example, a second type edge pointing from node cc2 to node cc3 represents an action of changing a source component configuration represented by node cc2 to a target component configuration represented by node cc3.

In an example, a weight of the second type edge may be associated with a cost of changing a source component configuration to a target component configuration (referred to below as a change operation) (the higher the cost, the smaller the weight of the second type edge). In an example, the absence of an edge between a first type node and a second type node may represent that a cost of changing the component configuration represented by the first type node to the component configuration represented by the second type node (or changing the component configuration represented by the second type node to the component configuration represented by the first type node) is infinitely high, thereby resulting in an edge weight of 0. For example, the weight of the second type edge may be predetermined based on a labor cost of the change operation and the cost of machine suspension. For example, the labor cost of the change operation may be calculated based on a product of the number of people required for the change operation, a time required for changing, and the weight of the labor in the change operation, and the cost of the machine suspension of the change operation may be calculated based on the machine suspension time caused by the change operation.

A third type edge whose two ends are connected to the same second type node may represent: an action of changing a source component configuration represented by the one second type node to a target component configuration represented by the one second type node (i.e., the component configuration is not actually changed). For example, an edge whose two ends are connected to node cc1 represents changing a source component configuration represented by node cc1 to a target component configuration represented by node cc1. A weight of the third type edge may be predetermined to be 1 or a value greater than a threshold.

By representing the state information of the environment in which the production equipment is located with the state diagram, it is possible to reflect in detail a many-to-many relationship among the product or the processing step of the product, the production equipment, and the component, thereby allowing adaptation to different environments.

The action of changing the component configuration is represented by one side in the state graph, which may determine a specific configuration change precisely. Graph weights related to the cost of changing may more efficiently improve the production efficiency.

FIG. 5 shows another example for obtaining state information according to some example embodiments.

As shown in FIG. 5, state information of an environment in which production equipment is located may be represented using a state matrix 300. In an example, each state matrix may have the same size as an adjacency matrix of the state diagram 200.

Same rows of respective state matrixes represent a same kind of source component configuration, same columns of respective state matrixes represent a same kind of target component configuration, and an element of an i-th row and a j-th column of each state matrix represents an attribute corresponding to an action of changing a source component configuration represented by the i-th row to a target component configuration represented by the j-th column. When the source component configuration represented by the i-th row cannot be changed to the target component configuration represented by the j-th column, the element of the i-th row and the j-th column of the state matrix may be set to zero. The source component configuration represented by the i-th row cannot be changed to the target component configuration represented by the j-th column when no target component configuration represented by the j-th column exists.

The state information may be represented using two state matrixes. For example, an element of an i-th row and a j-th column of a first state matrix may represent: a change in the number of kinds of products that production equipment is capable of processing or a change in the number of kinds of processing steps that the production equipment is capable of performing on products, before and after changing the source component configuration represented by the i-th row to the target component configuration represented by the j-th column; and an element of an i-th row and a j-th column of a second state matrix may represent: a cost (a labor cost and a cost of machine suspension) of changing the source component configuration represented by the i-th row to the target component configuration represented by the j-th column. However, the number of state matrixes for representing the state information is not limited thereto and a third state matrix may also be used, where an element of an i-th row and a j-th column of the third state matrix may represent a change in the number of products that the production equipment is capable of processing before and after changing the source component configuration represented by the i-th row to the target component configuration represented by the j-th column.

FIG. 6 shows an example for obtaining latent features according to some example embodiments.

In an example, a node feature corresponding to each node of the first type nodes and the second type nodes and a graph feature 204 corresponding to all of the first type nodes and the second type nodes may be obtained from a state graph 200 (e.g., a state graph 200 of FIG. 4) by a first neural network 202.

Here, the first neural network 200 may be a graph neural network. For example, the node feature corresponding to each of the first type nodes and the second type nodes may be obtained by a message passing and information aggregation operation based on a graph attention mechanism of multiple layers; and the graph feature 204 corresponding to all of the first type nodes and the second type nodes may be obtained by a readout operation.

A candidate action feature corresponding to a candidate action represented by each second type edge may be obtained, based on two node features corresponding to two nodes at two ends of each second type edge. For example, the candidate action feature corresponding to the candidate action represented by each second type edge may be obtained by concatenating the two node features corresponding to the two nodes at the two ends of each second type edge. In addition, an order in which the two node features corresponding to the two nodes at the two ends of each second type edge are concatenated may also be determined according to a direction of the directed second type edge.

For example, a candidate action feature (a, b, c, d) corresponding to a second type edge pointing from a cc3 node to a cc2 node may be obtained by concatenating a node feature (a, b) corresponding to the cc3 node with a node feature (c, d) corresponding to the cc2 node; and a candidate action feature (c, d, a, b) corresponding to a second type edge pointing from the cc2 node to the cc3 node may be obtained by concatenating the node feature (c, d) corresponding to the cc2 node with the node feature (a, b) corresponding to the cc3 node.

As described above with reference to FIG. 2, the second type edge pointing from the cc3 node to the cc2 node may represent a candidate action of changing a source component configuration represented by the cc3 node to a target component configuration represented by the cc2 node, and the second type edge pointing from the cc2 node to the cc3 node may represent a candidate action of changing a source component configuration represented by the cc2 node to a target component configuration represented by the cc3. Thus, the candidate action feature corresponding to the second type edge pointing from the cc3 node to the cc2 node may be the candidate action feature corresponding to the candidate action represented by the second type edge pointing from the cc3 node to the cc2 node; and the candidate action feature corresponding to the second type edge pointing from the cc2 node to the cc3 node may be the candidate action feature corresponding to the candidate action represented by the second type edge pointing from the cc2 node to the cc3 node.

A global change feature 206 may be obtained from global change information 201 by a second neural network 203. For example, the second neural network 203 may be an MLP or a CNN, however, embodiments are not limited thereto, and the second neural network 203 may also be other neural networks.

In an example, latent features 207 corresponding to the candidate actions may be obtained by merging (e.g., concatenating) the candidate action feature corresponding to the candidate action represented by each second type edge, the graph feature, and the global change feature.

FIG. 7 shows another example for obtaining latent features according to some example embodiments.

In an example, candidate action features 305 corresponding to candidate actions may be obtained from a state matrix 300 (e.g., a state diagram 300 of FIG. 5) by a first neural network 302.

Here, the first neural network 302 may be at least one of various types of a CNN, a region with convolution neural network (R-CNN), a generative adversarial network (GAN), a region proposal network (RPN), a recurrent neural network (RNN), a stacking-based deep neural network (S-DNN), a state space dynamic neural network (S-SDNN), a deconvolution network, a deep belief network (DBN), a restricted Boltzmann machine (RBM), a fully convolutional network, a long short-term memory (LSTM) network, a classification network, a plain residual network, a dense network, or the like; however, examples are not limited thereto, and the first neural network 302 may be other neural networks.

A global change feature 306 may be obtained from global change information 301 by a second neural network 303. The second neural network 303 may be the same as the second neural network 203 described with reference to FIG. 5.

Latent features 307 corresponding to the candidate actions may be obtained by merging (e.g., concatenating) the plurality of candidate action features 305 and the global change feature 306.

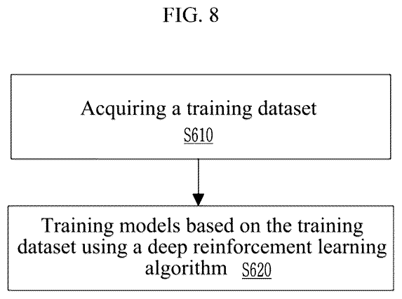

FIG. 8 shows a method for training an agent according to some example embodiments.

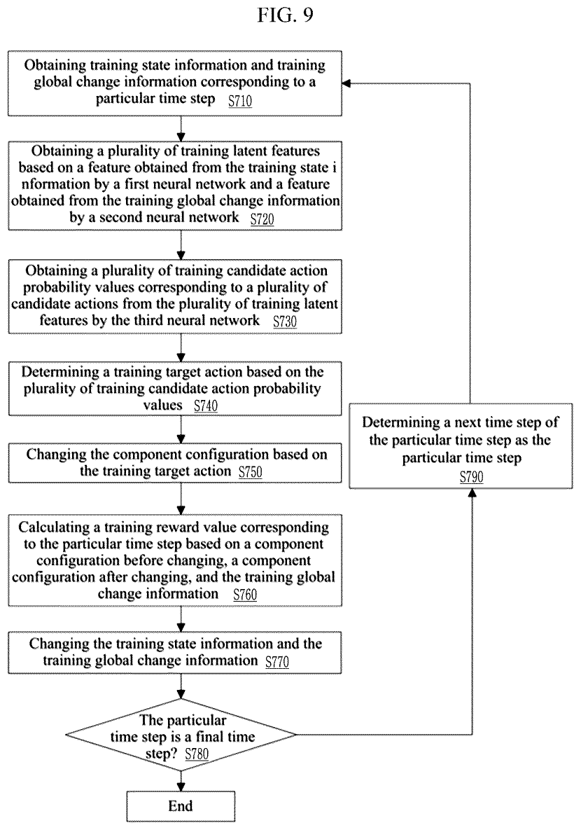

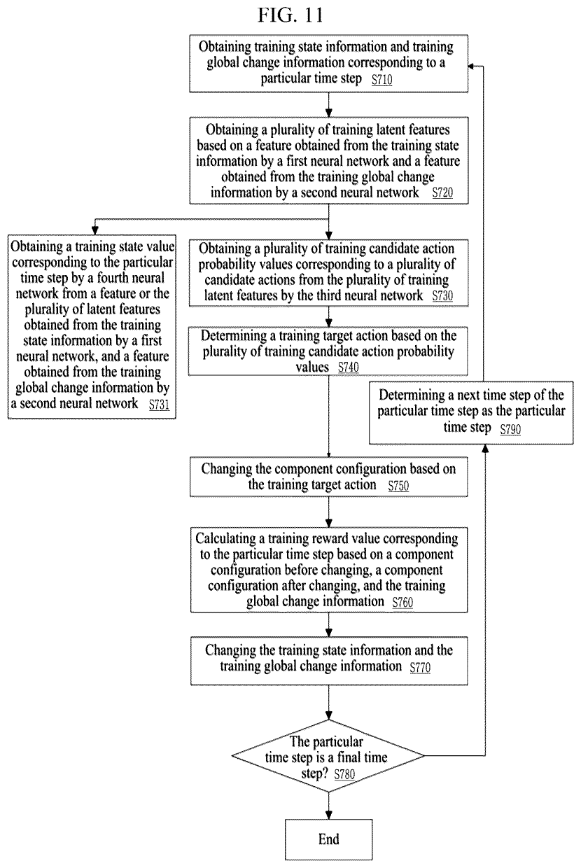

As shown in FIG. 8, in step S610, a training dataset may be acquired, the training dataset including training data corresponding to multiple time steps. Below, an example of obtaining each training data in a training dataset for training a first agent (or referred to as a first component configuration change model) is described with reference to FIG. 9, and an example of obtaining a training dataset for training a second agent (or referred to as a second component configuration change model) is described with reference to FIG. 11.

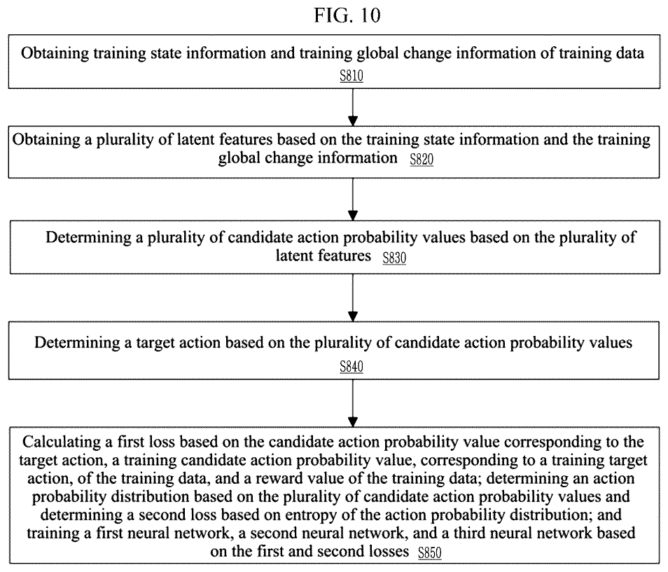

In step S620, the first component configuration change model or the second component configuration change model described above is trained based on the training dataset using a deep reinforcement learning algorithm. For example, the deep reinforcement learning algorithm may be one of a proximal policy optimization (PPO) algorithm and a deep Q-network (DQN) algorithm, however, examples are not limited thereto, and the deep reinforcement learning algorithm may be other algorithms. Below, an example of training the first agent using the PPO algorithm is described with reference to FIG. 10, and an example of training the second agent using the PPO algorithm is described with reference to FIG. 11.

In the present application, using the offline training process of the reinforcement learning algorithm, only the trained model needs to be scheduled to make a direct decision every time changing the component configuration using the agent, which improves the efficiency of changing the component configuration.

FIG. 9 shows an example for obtaining training data according to some example embodiments.

As shown in FIG. 9, in step S710, training state information and training global change information corresponding to a particular time step may be obtained.

In an example, the training state information may be obtained from a simulation environment module that simulates an environment of a workshop/facility where a product is manufactured or tested. For example, the above-described environment may be simulated by discrete event simulation (DES). However, examples are not limited thereto, and other methods of simulating the above-described environment may be used, which is not limited in the present invention.

In step S720, latent features may be obtained based on a feature obtained from the training state information by a first neural network and a feature obtained from the training global change information by a second neural network. In step S730, training candidate action probability values respectively corresponding to candidate actions may be obtained from the latent features by the third neural network. In step S740, a training target action may be determined based on the training candidate action probability values. For example, a probability distribution of an action space obtained based on the training candidate action probability values may be randomly sampled to determine a sampled training candidate action probability value, and a candidate action corresponding to the sampled training candidate action probability value may be determined as a training target action. In step S750, the component configuration may be changed based on the training target action.

Steps S720, S730, and S750 may be performed similarly to steps S120, S130 and S150 of FIG. 3.

In step S760, a training reward value corresponding to the particular time step may be calculated based on a component configuration before changing, a component configuration after changing, and the training global change information.

In an example, total production capacity of the environment before changing the component configuration may be calculated based on the component configuration before changing, total production capacity of the environment after changing the component configuration may be calculated based on the component configuration after changing, a cost corresponding to changing the component configuration may be calculated based on the training global change information, and a training reward value may be calculated based on the total production capacity of the environment before changing the component configuration, the total production capacity of the environment after changing the component configuration, and the cost corresponding to changing the component configuration.

In an example, the training reward value may be calculated based on Equation 1.

$$r ( t ) = {Y}_{a} ( t ) - {Y}_{b} ( t ) - C ( t ) \qquad Equation 1$$

In Equation 1, r(t) represents a reward value corresponding to a time step t, Yₐ(t) represents total production capacity of the environment before changing the component configuration corresponding to the time step t, Yₚ(t) denotes total production capacity of the environment after changing the component configuration corresponding to the time step t, and C(t) represents a cost corresponding to changing the component configuration, corresponding to the time step t.

In an example, the total production capacity of the environment may be calculated based on Equation 2.

$$Y = {[ \frac{{\sum }_{i ∈ P}^{\vert P \vert} ( {T}_{i} - {g}_{i} ) {n}_{i}}{\sum {n}_{i}} ]}_{m} \qquad Equation 2$$

In Equation 2, P is a set of all component configurations, Tᵢ represents a testing time of production equipment in a future expectation m when the component configuration is i, gᵢ is an idle time of the production equipment in the future expectation m, and nᵢ is the number of production equipment installed with component configuration i.

The future expectation m represents an average of future runnable time of all production equipment, i.e., the average time required to process all products or processing steps of all products. For example, the future expectation m may be calculated based on Equation 3.

$$m = \frac{{\sum }_{i ∈ P}^{\vert P \vert} {T}_{i} {n}_{i}}{\sum {n}_{i}} \qquad Equation 3$$

However, the way of calculating the total production capacity of the environment is not limited to the foregoing and other known ways of calculating the total production capacity of the environment may be used.

In an example, a cost corresponding to changing the component configuration may be calculated based on the training global change information, a labor cost of changing the component configuration, and a machine cost of changing the component configuration. For example, the cost corresponding to changing the component configuration may be calculated based on Equation 4.

$$C = \frac{w}{{s}^{1.1}} ( {nTw}_{m} + R ) \qquad Equation 4$$

In Equation 4, n represents the number of people required to change the component configuration, T represents the labor operation time required to change the component configuration, wₘ is a weight of labor in an operation of changing the component configuration, R represents the machine suspension time caused by changing the component configuration, s represents the training global change information (e.g., a time from a time at which the particular time step is performed to a time when the component configuration was changed last time), and w represents an overall change weight associated with a component of the production equipment.

In step S770, the training state information and the training global change information may be changed.

In an example, the changed component configuration may be applied to a simulation environment module, and thereafter, the training state information generated by the simulation environment module is also changed. In addition, the training global change information may be changed, for example, the number of times the component configuration has been changed may be increased by one.

In step S780, it may be determined whether the particular/current time step is a predetermined final time step.

When the particular/current time step is the final time step, the processing may end. When the particular time step is not the final time step, a next time step of the particular time step may be determined as the particular time step, and steps S710 to S780 may be repeated, at the next time step of the particular time step.

In an example, training data corresponding to any time step may include: training state information corresponding to any time step, training global change information corresponding to any time step, a training candidate action probability value (a sampled training candidate action probability value) corresponding to a training target action corresponding to any time step, and a training reward value corresponding to any time step.

FIG. 10 shows an example of training a first component configuration change model using a PPO algorithm according to some example embodiments.

As shown in FIG. 10, in step S810, training state information and training global change information of training data may be obtained. In step S820, latent features may be obtained based on the training state information and the training global change information. In step S830, candidate action probability values may be determined based on the latent features. Steps S820 and S830 may be performed similarly to steps S120 and S130 of FIG. 3.

In step S840, a target action may be determined based on the candidate action probability values. For example, a candidate action corresponding to any of the candidate action probability values may be determined as the target action.

In step S850, a first loss may be calculated based on the candidate action probability value corresponding to the target action determined in step S840, a training candidate action probability value, corresponding to a training target action, of the training data, and a reward value of the training data; an action probability distribution may be determined based on the plurality of candidate action probability values and a second loss may be determined based on entropy of the action probability distribution; and a first neural network, a second neural network, and a third neural network may be trained based on the first and second losses.

The reward value of the training data may be applied to an advantage function, an objective function may be determined based on “a ratio of the training candidate action probability value, corresponding to the training target action, of the training data to the candidate action probability value corresponding to the target action” and the advantage function, and the first loss may be determined based on the objective function.

In an example, the first neural network, the second neural network, and the third neural network may be trained based on a weighted sum of the first loss and the second loss.

FIG. 11 shows another example for obtaining training data according to some example embodiments.

The method for obtaining the training data illustrated in FIG. 11 differs from the method for obtaining the training data illustrated in FIG. 9 in that the method for obtaining the training data illustrated in FIG. 11 further comprises a step S731.

In step S731, a training state value corresponding to a particular time step may be obtained by a fourth neural network based on a feature or the latent features obtained from training state information by a first neural network, and a feature obtained from the training global change information by a second neural network.

In a case where the first neural network is a GNN, similar to what is described with reference to FIG. 6, a training graph feature may be obtained from the training state information (e.g., a training state graph) by the first neural network, a training global change feature may be obtained from the training global change information by the second neural network, and the training state value may be obtained from the training graph feature and the training global change feature by the fourth neural network values.

In a case where the first neural network is a CNN, similar to what is described with reference to FIG. 7, a training candidate action feature may be obtained from the training state information (e.g., a training state matrix) by the first neural network, the training global change feature may be obtained from the training global change information by the second neural network, and the training state value may be obtained from the training candidate action feature and the training global change feature by the fourth neural network.

Here, training data corresponding to any time step may include: training state information corresponding to any time step, training global change information corresponding to any time step, a training candidate action probability value, corresponding to a training target action, corresponding to any time step, a training reward value corresponding to any time step, and a training state value corresponding to any time step.

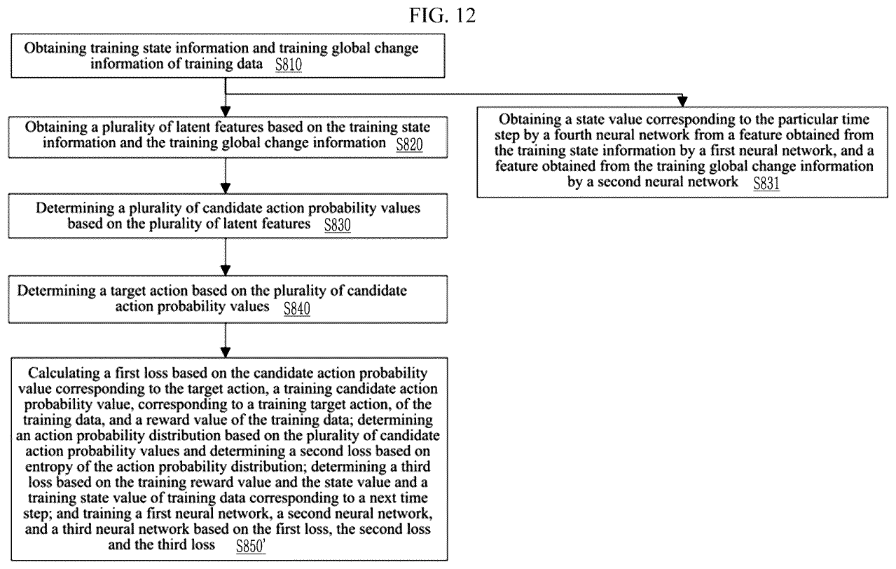

FIG. 12 shows an example of training a second component configuration change model using a PPO algorithm according to some example embodiments.

The method for training the second component configuration change model illustrated in FIG. 12 differs from the method for training the first component configuration change model illustrated in FIG. 10 in steps S831 and S850′.

In step S831, a state value may be obtained similarly to step S731.

Step S850′ differs from step S850 in that step S850′ further comprises: determining a third loss based on the state value, a training reward value, and a training state value of training data corresponding to a next time step; and training the first neural network, second neural network, and the third neural network based on a first loss, a second loss, and the third loss.

For example, in step S831, a state value as an output value of a fourth neural network may be determined based on a feature or latent features obtained from training state information of training data corresponding to a particular time step by the first neural network. In step S850′, a ground truth may be determined based on (e.g., a sum of) a training reward value of the training data corresponding to the particular time step and a training state value of training data corresponding to a next time step of the particular time step; a third loss may be determined based on a difference between the ground truth and the state value determined in step S831.

By training the component configuration change models using a deep reinforcement learning algorithm, the component configuration change models may change the component configuration to adjust the state of the production capacity and improve the production efficiency.

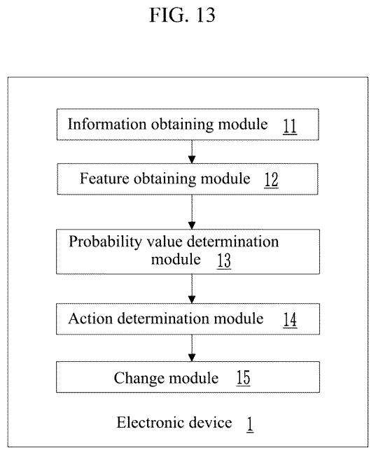

FIG. 13 shows an electronic device according to some example embodiments.

An electronic device according to various example embodiments of the present disclosure may include, for example, a desktop computer, a laptop computer, a tablet computer, a server system, and the like. However, the present disclosure is not limited thereto, and the electronic device according to the present disclosure may be any electronic device having a function of changing the component configuration.

As shown in FIG. 13, the electronic device 1 may include an information obtaining module 11, a feature obtaining module 12, a probability value determination module 13, an action determination module 14, and a change module 15.

In an example, the information obtaining module 11 may obtain state information, corresponding to a current time step, of an environment in which production equipment is located and global change information. The state information and the global change information are described above with reference to FIGS. 2, 4, and 5.

In an example, the feature obtaining module 12 may obtain latent features corresponding to a plurality of candidate actions based on the state information and the global change information. The processing of obtaining the latent features is described above with reference to FIGS. 6 and 7.

The probability value determination module 13 may determine candidate action probability values respectively corresponding to the candidate actions based on the latent features corresponding to the candidate actions. For example, the candidate action probability values may be obtained from the latent features by a third neural network (e.g., a multilayer perceptron (MLP), a convolutional neural network (CNN), etc.).

The action determination module 14 may determine a target action based on the candidate action probability values. For example, a candidate action corresponding to the maximum candidate action probability value may be determined as the target action.

The change module 15 may change the component configuration based on the target action.

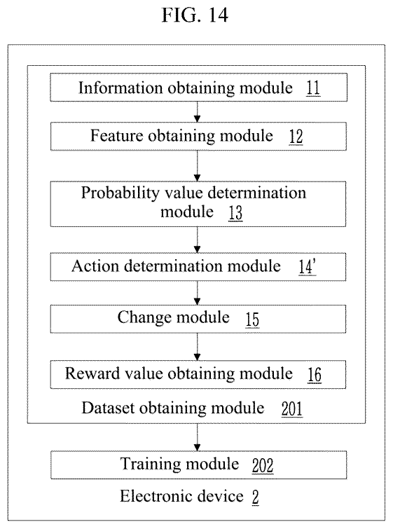

FIG. 14 shows an electronic device according to some example embodiments.

An electronic device according to various example embodiments of the present disclosure may include, for example, a desktop computer, a laptop computer, a tablet computer, a server system, and the like. However, the electronic device may be any electronic device having a function of training component configuration change models.

In an example, the electronic device 1 of FIG. 13 may be included in the electronic device 2 of FIG. 14.

As shown in FIG. 14, the electronic device 2 may include a dataset obtaining module 201 and a training module 202.

The dataset obtaining module 201 may obtain a training dataset including training data corresponding to time steps.

The dataset obtaining module 201 may include an information obtaining module 11, a feature obtaining module 12, a probability value determination module 13, an action determination module 14′, a change module 15, and a reward value obtaining module 16.

The information obtaining module 11 may obtain training state information and training global change information corresponding to any of the time steps.

The feature obtaining module 12 may obtain latent features based on a feature obtained from the training state information by a first neural network and a feature obtained from the training global change information by a second neural network.

The probability value determination module 13 may obtain training candidate action probability values respectively corresponding to candidate actions from the latent features by a third neural network.

In an example, the action determination module 14′ may determine a training target action based on the training candidate action probability values. For example, a probability distribution of an action space obtained based on the plurality of training candidate action probability values may be randomly sampled to determine the sampled training candidate action probability value, and a candidate action corresponding to the sampled training candidate action probability value may be determined as a training target action.

The change module 15 may change the component configuration based on the training target action.

The reward value obtaining module 16 may calculate a training reward value corresponding to a particular time step based on a component configuration before changing, a component configuration after changing, and the training global change information.

Training data corresponding to any time step may include: training state information corresponding to any time step, training global change information corresponding to any time step, a training candidate action probability value (a sampled training candidate action probability value), corresponding to a training target action, corresponding to any time step, and a training reward value corresponding to any time step.

The dataset obtaining module 201 may also include a state value obtaining module.

The state value obtaining module may obtain, a training state value corresponding to a particular time step, by a fourth neural network based on a feature or the plurality of latent feature obtained from the training state information by the first neural network, and a feature obtained from the training global change information by the second neural network.

Training data corresponding to any time step may include: training state information corresponding to any time step, training global change information corresponding to any time step, a training candidate action probability value, corresponding to a training target action, corresponding to any time step, a training reward value corresponding to any time step, and a training state value corresponding to any time step.

The training module 202 may train component configuration change models (e.g., the first component configuration change model or the second component configuration change model described above) based on the training dataset use a deep reinforcement learning algorithm.

The processing of training the component configuration change models is described above with reference to FIGS. 10 and 12.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In an example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples plurality of processors or computers may be used, or a processor or computer may include plurality of processing elements, or plurality of types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction plurality of-data (SIMD) multiprocessing, plurality of-instruction single-data (MISD) multiprocessing, and plurality of-instruction plurality of-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions or software include machine code that is directly executed by the processor or computer, such as machine code produced by a compiler. In another example, the instructions or software include higher-level code that is executed by the processor or computer using an interpreter. Programmers of ordinary skill in the art may readily write the instructions or software based on the block diagrams and the flow charts illustrated in the drawing and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

The computing apparatuses, the electronic devices, the processors, the memories, the information output system and hardware, the storage devices, and other apparatuses, devices, units, modules, and components described herein with respect to FIGS. 1-14 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-14 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for changing a component configuration of an apparatus, comprising:
obtaining global change information and state information, the state information corresponding to a current time step, of an environment in which the apparatus is located;
obtaining latent features corresponding to candidate actions, based on the state information and the global change information;
determining candidate action probability values respectively corresponding to the candidate actions, the determining based on the latent features corresponding to the candidate actions;
determining a target action based on the candidate action probability values; and
changing the component configuration based on the target action.

2. The method of claim 1, further comprising: changing the state information of the environment based on the changed component configuration, and changing the global change information.

3. The method of claim 1, wherein the global change information includes information about the number of times that the component configuration has been changed and information about a time duration from a time at which the current time step is performed to a time when the component configuration was last changed.

4. The method of claim 1, wherein the state information of the environment at the current time step is represented by a state graph or a state matrix.

5. The method of claim 4,
wherein the state graph includes first type nodes, second type nodes, first type edges connecting the first type nodes and the second type nodes, and second type edges connecting second type nodes to each other,
wherein each first type node represents a kind of product processed by the apparatus or a kind of processing step by which the apparatus processes a kind of product, and each second type node represents a kind of component configuration, and
wherein a second type edge, pointing from one node of the two second type nodes to the other node, connecting the two second type nodes represents an action of changing a component configuration represented by the one node to a component configuration represented by another node, a weight of the second type edge represents a cost of changing from the component configuration represented by the one node to the component configuration represented by another node, and the weight of the second type edge are predetermined.

6. The method of claim 5, wherein the obtaining of the latent features corresponding to the candidate actions comprises:
obtaining a node feature corresponding to each node of the first type nodes and the second type nodes and a graph feature corresponding to all of the first type nodes and the second type nodes, from the state information by a first neural network;
obtaining a candidate action feature corresponding to a candidate action represented by each second type edge, based on two node features respectively corresponding to two second type nodes connected by each second type edge;
obtaining a global change feature from the global change information by a second neural network; and
obtaining the latent features corresponding to the candidate actions by merging the candidate action feature corresponding to the candidate action represented by each second type edge, the graph feature, and the global change feature.

7. The method of claim 4, wherein the state matrix comprises a first matrix and a second matrix, wherein same rows of the matrixes represent a same kind of source component configuration, same columns of the matrixes represent a same kind of target component configuration, and an element of an i-th row and a j-th column of each matrix represents an attribute corresponding to an action of changing a source component configuration represented by the i-th row to a target component configuration represented by the j-th column,
wherein the element of the i-th row and the j-th column of the first matrix represents: a change in the number of kinds of products that the apparatus is capable of processing or a change in the number of kinds of processing steps that the apparatus is capable of performing on products, before and after changing the source component configuration represented by the i-th row to the target component configuration represented by the j-th column, and
wherein the element of the i-th row and the j-th column of the second matrix represents: a cost of changing the source component configuration represented by the i-th row to the target component configuration represented by the j-th column.

8. The method of claim 7, wherein the obtaining of the latent features corresponding to the candidate actions comprises:
obtaining candidate action features corresponding to the candidate actions from the state matrix by a first neural network,
obtaining a global change feature from the global change information by a second neural network; and
obtaining the latent features corresponding to the candidate actions by merging each of the candidate action features with the global change feature.

9. The method of claim 1, wherein the determining of the candidate action probability values respectively corresponding to the candidate actions comprises:
obtaining the candidate action probability values from the latent features by a third neural network.

10. The method of claim 1, wherein the determining of the target action based on the candidate action probability values comprises: determining a candidate action corresponding to the largest candidate action probability value as a target action.

11. A computer-readable storage medium storing a computer program that, when executed by a processor, performs the method of claim 1.

12. An electronic device comprising:
one or more processors; and
memory storing instructions configured to cause the one or more processors to:
obtain state information, corresponding to a current time step, of an environment in which a component configurable apparatus is located and global change information;
obtain latent features corresponding to candidate actions, based on the state information and the global change information;
determine candidate action probability values respectively corresponding to the candidate actions, based on the latent features corresponding to the candidate actions; and
determine a target action based on the candidate action probability values; and
change the component configuration based on the target action.

13. The electronic device of claim 12,
wherein the state graph which represents the state information of the environment at the current time step includes first type nodes, second type nodes, first type edges connecting the first type nodes and the second type nodes, and second type edges connecting second type nodes to each other,
wherein each first type node represents a kind of product processed by the apparatus or a kind of processing step by which the apparatus processes a kind of product, and each second type node represents a kind of component configuration, and
wherein a second type edge, pointing from one node of the two second type nodes to the other node, connecting the two second type nodes represents an action of changing a component configuration represented by the one node to a component configuration represented by another node, a weight of the second type edge represents a cost of changing from the component configuration represented by the one node to the component configuration represented by another node, and the weight of the second type edge are predetermined.

14. The electronic device of claim 13, wherein the obtaining of the latent features corresponding to the candidate actions comprises:
obtaining a node feature corresponding to each node of the first type nodes and the second type nodes and a graph feature corresponding to all of the first type nodes and the second type nodes, from the state information by a first neural network;
obtaining a candidate action feature corresponding to a candidate action represented by each second type edge, based on two node features respectively corresponding to two second type nodes connected by each second type edge;
obtaining a global change feature from the global change information by a second neural network; and
obtaining the latent features corresponding to the candidate actions by merging the candidate action feature corresponding to the candidate action represented by each second type edge, the graph feature, and the global change feature.

15. The electronic device of claim 14, wherein the obtaining a node feature corresponding to each node of the first type nodes and the second type nodes and a graph feature corresponding to all of the first type nodes and the second type nodes, from the state information by a first neural network comprises:
obtaining the node feature through a message passing and information aggregation operation based on a graph attention mechanism of multiple layers; and
obtaining the graph feature through a readout operation.

16. The electronic device of claim 14, wherein the obtaining a candidate action feature corresponding to a candidate action represented by each second type edge, based on two node features respectively corresponding to two second type nodes connected by each second type edge comprises
obtaining the candidate action feature by concatenating a first node feature and a second node feature of the two node features, wherein the first node feature corresponds to one of the two second type nodes and the second node feature corresponds to the other of the two second type nodes.

17. The electronic device of claim 12, wherein the state matrix which represents the state information of the environment at the current time step comprises a first matrix and a second matrix, wherein same rows of the matrixes represent a same kind of source component configuration, same columns of the matrixes represent a same kind of target component configuration, and an element of an i-th row and a j-th column of each matrix represents an attribute corresponding to an action of changing a source component configuration represented by the i-th row to a target component configuration represented by the j-th column,
wherein the element of the i-th row and the j-th column of the first matrix represents: a change in the number of kinds of products that the apparatus is capable of processing or a change in the number of kinds of processing steps that the apparatus is capable of performing on products, before and after changing the source component configuration represented by the i-th row to the target component configuration represented by the j-th column, and
wherein the element of the i-th row and the j-th column of the second matrix represents: a cost of changing the source component configuration represented by the i-th row to the target component configuration represented by the j-th column.

18. The electronic device of claim 17, wherein the obtaining of the latent features corresponding to the candidate actions comprises:
obtaining candidate action features corresponding to the candidate actions from the state matrix by a first neural network,
obtaining a global change feature from the global change information by a second neural network; and
obtaining the latent features corresponding to the candidate actions by merging each of the candidate action features with the global change feature.

19. The electronic device of claim 12, wherein the determining of the candidate action probability values respectively corresponding to the candidate actions comprises:
obtaining the candidate action probability values from the latent features by a third neural network.

20. The electronic device of claim 12, wherein the determining of the target action based on the candidate action probability values comprises: determining a candidate action corresponding to the largest candidate action probability value as a target action.
